(19) United States
(12) Patent Application Publication
(10) Pub. No.: US 2018/0107892 A1
(43) Pub. Date: Apr. 19, 2018

(54) DUAL EMBEDDED OPTICAL CHARACTER RECOGNITION (OCR) ENGINES

(71) Applicant: 3M INNOVATIVE PROPERTIES COMPANY, St. Paul, MN (US)

(72) Inventors: Peter ISTENES, Budapest (HU); Stephanie R. SCHUMACHER, York (GB); Benjamin W. WATSON, Hampshire (GB)

(21) Appl. No.: 15/568,212

(22) PCT Filed: Apr. 6, 2016
(86) PCT No.: PCT/US2016/026094

§ 371 Date: Oct. 20, 2017

Related U.S. Application Data
(60) Provisional application No. 62/149,809, filed on Apr. 20, 2015.

(51) Int. Cl. G06K 9/32; G06K 9/62; G06K 9/18

(52) U.S. Cl. CPC G06K 9/3258; G06K 9/18; G06K 9/6292

(57) ABSTRACT

A camera system with dual embedded optical character recognition (OCR) engines. The camera system includes a camera module for capturing an image of a vehicle, the image including a license plate with a license plate number containing characters; a first OCR engine that produces a first read and first confidence level by extracting the characters from the license plate; and a second OCR engine, different from the first OCR engine, that produces a second read and second confidence level extracting the characters from the license plate. The camera system further includes a comparator for comparing the first read to the second read. If the first read and the second read match, the system produces the matching read as a final read. If the first read and the second read do not match, a fusion module produces a final read using the first read, the first confidence level, the second read, and the second confidence level.

### TECHNICAL FIELD

The present disclosure relates to the field of optical character recognition for automatic number plate recognition (ANPR) or automatic license plate recognition (ALPR) systems. More specifically, the present disclosure relates to using two different optical character recognition (OCR) engines to identify the characters on a license plate.

### BACKGROUND

ANPR and ALPR systems (used interchangeably herein) are used in a variety of intelligent transportation and traffic management systems. For example, ALPR systems can be used for reading a license plate (also referred to as a number plate or plate) of a vehicle passing below a gantry on a toll road so that a bill or fine for the toll can be sent to individual associated with the license plate registration.

ALPR systems can be used in parking enforcement to monitor whether a vehicle has been parked at a time-limited parking location for too long of a length of time as described in U.S. Pat. No. 7,579,965 to Bucholz, incorporated herein by reference.

ALPR systems can be used to locate missing or stolen vehicles. In such an application, a vehicle with a mobile ALPR system mounted may detect the license plate numbers or parked or moving vehicles it passes as it is driven. The system may compare detected license plate numbers to a “hot list” of license plates including stolen vehicles or vehicles registered to individuals who are wanted for other civil or criminal reasons. Such an application is described in U.S. Pat. No. 7,881,498 to Simon, incorporated herein by reference.

In each of these and other ALPR applications, it is important to maximize the read accuracy of a license plate. The characters on a license plate can be difficult for an OCR engine to detect for a variety of reasons. For example, many license plates have a variety of designs or pictures included to indicate what country or state the plate is from, to support a special cause, or to allow a motorist to select a plate that they like. These designs or pictures can make it more difficult to detect characters on the plate when the pictures overlap the characters or even when the pictures are located on a perimeter of the plate.

In other instances, plates can be dirty or can be partially or fully covered or obscured by snow, sand, a license plate frame, tow bars or hitches, or other objects or debris that may obscure the plate. Plates also age with time and may become damaged due to weather or impact, such as in a traffic accident.

A variety of approaches are used to ensure accurate plate reads, or character recognition. One approach is to collect an image of the plate illuminated by each of visible light and infrared light. One or both of these images can be used to ensure better read accuracy as discussed by U.S. Patent Application No. 62/036,797 “Optically Active Articles and Systems In Which They May Be Used” as filed by the Applicant on Aug. 13, 2014 and incorporated herein by reference.

Additionally, a variety of types of OCR engines or systems can be used to read the characters on a license plate. However, various OCR engines have varying results and levels of accurate read rates based on the algorithm used by the particular engine.

An improvement in accurately identifying characters on a license plate would be welcomed.

### SUMMARY

The present disclosure provides a variety of advantages over the status quo. For example, the present disclosure allows for increased accuracy of license plate read results. Increased accuracy can be achieved on an individual character level or with respect to the entire license plate number. The use of read results from more than one different OCR engine enables increased accuracy.

The present disclosure also allows for verification of a license plate read in real time using multiple different OCR engines.

The present disclosure allows for increased confidence of read accuracy. In many tolling or other solutions, an operator will not take action to send a ticket or fine to a violator or otherwise allow a pre-paid customer through a tolling area, unless the read is a high-confidence read, without a manual confirmation of an accurate plate read. The manual confirmation occurs by a person visually comparing the license plate number read to an image of a license plate.

The present disclosure can increase the proportion of high confidence reads. Additionally, high confidence reads can result in overall increased system accuracy. One such way a system can have high confidence that a read is accurate is when two different OCR engines produce the same read result for a single license plate number. The increased proportion of high confidence reads and increased accuracy can reduce manual effort required to confirm read accuracy. This can have significant financial benefits for a tolling or other system that may issue tickets by reducing the cost to operate the system by reducing manual effort required, and by decreasing the number of false positive reads and incorrectly issued tickets based on those false positives. The increased accuracy resulting from the present disclosure may also increase the number of correct reads forming the basis for issuing tickets.

In one instance, the present disclosure includes a camera system with dual embedded optical character recognition (OCR) engines. The camera system includes a camera module for capturing an image of a vehicle, the image including a license plate with a license plate number containing characters; a first OCR engine that produces a first read and first confidence level by extracting the characters from the license plate; and a second OCR engine, different from the first OCR engine, that produces a second read and second confidence level extracting the characters from the license plate. The camera system further includes a comparator for comparing the first read to the second read. If the first read and the second read match, the system produces the matching read as a final read. If the first read and the second read do not match, a fusion module produces a final read using the first read, the first confidence level, the second read, and the second confidence level.

In another instance the present disclosure includes a method for producing a license plate final read. The method includes providing a camera system with dual embedded optical character recognition (OCR) engines, wherein the camera system comprises a camera module, a first OCR engine, a second OCR engine, a comparator and a fusion module. The method further includes capturing, with the camera module, an image of a vehicle, the image including a license plate with a license plate number containing characters; producing a first read and first confidence level by extracting the characters from the license plate with the feature-based OCR engine; and producing a second read and second confidence level extracting the characters from the license plate with the pattern-based OCR engine. The method further includes comparing the first read to the second read. If the first read and the second read match producing the matching read as a final read. If the first read and the second read do not match, producing a final read with the fusion module, using the first read, the first confidence level, the second read, and the second confidence level.

In another instance, the present disclosure includes a camera system with dual embedded optical character recognition (OCR) engines. The system comprises a camera module for capturing an image of a vehicle, the image including a license plate with a license plate number containing characters; a first OCR engine that produces a first read and first confidence level by extracting the characters from the license plate; and a second OCR engine that produces a second read and second confidence level extracting the characters from the license plate. The system further comprises a comparator for comparing the first read to the second read. If the first read and the second read match, the system produces the matching read as a final read. If the first read and the second read do not match, a fusion module produces a final read using the first read, the first confidence level, the second read, and the second confidence level.

In some embodiments, the fusion module selects at least one character from the first read and at least one character from the second read to produce the final read.

In some embodiments, the fusion module provides a third confidence level associated with the final read. Further, in some instances, if the third confidence level is below a predefined threshold, the final read is designated as invalid.

In some embodiments the feature-based OCR engine and the pattern-based OCR engine evaluate the same image to produce the first read and the second read.

In some embodiments, the feature-based OCR engine and the pattern-based OCR engine evaluate different images to produce the first read and the second read.

In some embodiments, the feature-based OCR engine produces the first read from information received through a first channel, and wherein the pattern-based OCR engine produces the second read from information received through the second channel.

### BRIEF DESCRIPTION OF DRAWINGS

The following figures provide illustrations of the present invention. They are intended to further describe and clarify the invention, but not to limit scope of the invention.

FIG. 1 is an example of a license plate.

FIGS. 2a-2b are examples of images of the license plate.

FIG. 3 is an exemplary block diagram of a camera system with dual embedded OCR engines.

FIG. 4 is a process diagram for dual embedded OCR engines.

FIG. 5 is a process diagram for a fusion module.

Like numbers are generally used to refer to like components. The drawings are not to scale and are for illustrative purposes only.

### DETAILED DESCRIPTION

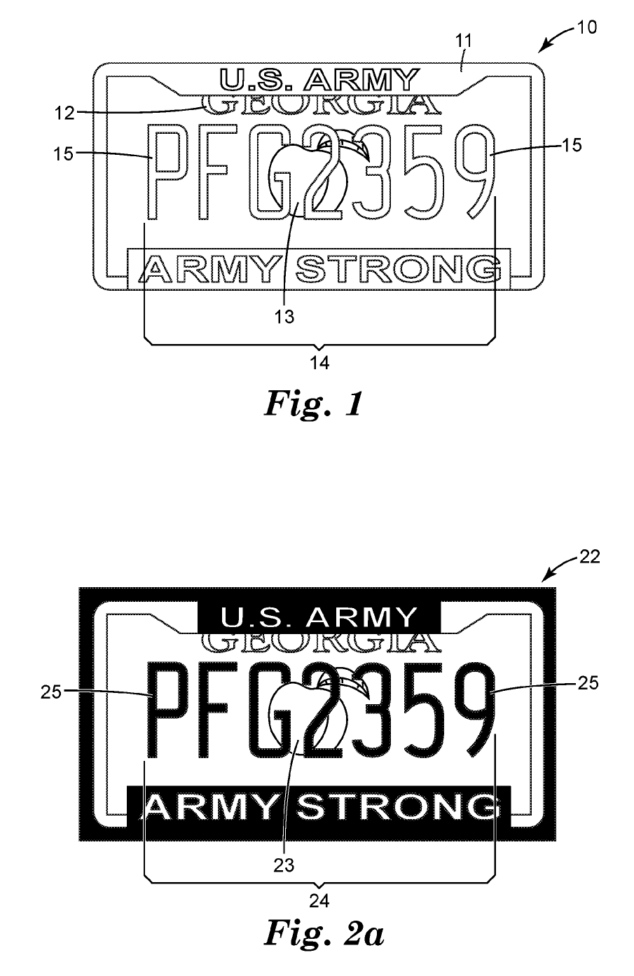

FIG. 1 is an example of a license plate 10. License plate 10 is surrounded by a plate frame 11. License plate 10 includes a state name 12, “Georgia”, an image of a peach 13, and license plate number 14. A license plate number is the alphanumeric identifier embossed or printed on a license plate. License plate number 14 is comprised of seven characters 15 in this instance. License plates numbers 14 may include more or fewer characters. Characters may include alphanumerics, graphics, symbols, logos, shapes and other identifiers.

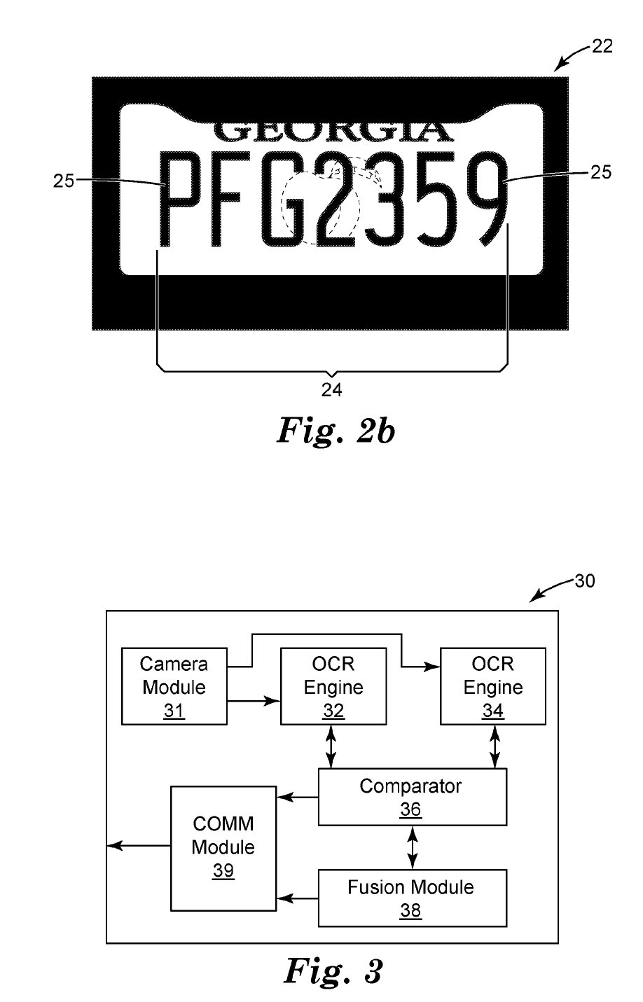

FIGS. 2a and 2b are images the license plate taken with illumination at different wavelengths. FIG. 2a is an image of the license plate 22 of FIG. 1 taken in visible light or the visible spectrum. The visible spectrum refers to the portion of the electromagnetic spectrum that is visible to (i.e., can be detected by) the human eye. A typical human eye will respond to wavelengths from about 390 to 700 nm. License plate 22 includes license plate number 24, made up of characters 25. The characters are somewhat obscured by the image of a peach 23 in the background.

FIG. 2b is an image of the same license plate 22 taken using illumination in the infrared spectrum. The term “infrared” refers to electromagnetic radiation with longer wavelengths than those of visible radiation, extending from the nominal red edge of the visible spectrum at around 700 nanometers (nm) to over 1000 nm. It is recognized that the infrared spectrum extends beyond this value. The term “near infrared” as used herein refers to electromagnetic radiation with wavelengths between 700 nm and 1300 nm.

Such an image could be captured by a sensor (detector) which is sensitive to infrared or ultraviolet radiation as appropriate and is able to detect retroreflected radiation outside of the visible spectrum. Exemplary commercially available cameras include but are not limited to the P372, P382, and P492 cameras sold by 3M Company.

The license plate 22 shown in each of FIGS. 2a and 2b may be an optically active article, such that it is a reflective and/or retroreflective article. A retroreflective article has the attribute of reflecting an obliquely incident radiation ray in a direction generally antiparallel to its incident direction such that it returns to the radiation source or the immediate vicinity thereof.

The images shown in FIGS. 2a and 2b are examples of images captured through different channels, where the image in FIG. 2a is captured in a color channel (illuminated off-axis) and the image in FIG. 2b is captured in a narrowband infrared channel (illuminated on-axis). Further discussion of different types of channels can be found in U.S. Patent Application No. 62/036,797 “Optically Active Articles and Systems In Which They May Be Used” as filed by the Applicant on Aug. 13, 2014 and incorporated herein by reference.

FIG. 3 is an exemplary block diagram of a camera system 30 with dual embedded OCR engines 32 and 34. Camera system 30 includes a camera module 31 for capturing an image of a vehicle, the image including a license plate with a license plate number containing characters. Camera module 31 may be capable of capturing more than one image through two or more separate channels simultaneously. In another embodiment, camera module 31 may capture subsequent images of the same license plate through a single channel or through two or more separate channels. One, two, or more captured images may be transmitted to first OCR engine 32 and second OCR engine 34. In some embodiments, the same image or images may be transmitted to each of first OCR engine 32 and second OCR engine 34, and in other embodiments, different images may be transmitted to each of first OCR engine 32 and second OCR engine 34. In some embodiments, camera system 30 may include more than two different OCR engines.

In embodiments where multiple images are captured by camera module 31, selection criteria may be used to identify candidate images most likely to contain readable plates. These candidate images are then prioritized for submission to the OCR engine. An image selection process step maintains a time ordered queue of candidate image records (each image record contains image metadata, including, for example, plate-find data). This queue has a limited length. As new image records arrive from the channels, they are evaluated against those image records already in the queue. If the new image record is deemed “better” than any already in the queue, or if the queue is not full, the new image record joins the back of the queue. If the queue is “full”, the weakest candidate currently in the queue is removed. While this is one method for handling image selection, other methods within the scope of the present invention will be apparent to one of skill in the art upon reading the present disclosure.

First OCR engine 32 produces a first read and first confidence level associated with the image received by first OCR engine 32 by extracting and correctly identifying the characters from the license plate number in the image. “Reading,” “reads,” or “read accuracy” means the machine interpretation of the license plate number or character contained on a license plate.

A confidence level is a percentage that defines the likelihood of a character or a license plate number being correct. First OCR engine 32 may produce a confidence level associated with the read of the entire license plate number and a confidence level associated with each character on the license plate or comprising part of the license plate number. First OCR engine 32 may produce similar sets of data for each image of a license plate that it processes.

Second OCR engine 34, different from the first OCR engine 32, produces a second read and second confidence level associated with the image received by the second OCR engine 34 by extracting and correctly identifying the characters from the license plate number in the image. Second OCR engine 34 may produce a confidence level associated with the read of the entire license plate number and a confidence level associated with each character on the license plate or comprising part of the license plate number. Second OCR engine 34 may produce similar sets of data for each image of a license plate that it processes. Additionally, an OCR engine may produce multiple alternate guesses for the plate read and produce similar sets of data for each guess.

First OCR engine 32 and second OCR engine 34 are different types of OCR engines. For example, in one embodiment, first OCR engine 32 may be a feature based OCR engine. A feature-based OCR engine recognizes or identifies characters based on features of a character, such as loops, lines, holes and corners. In one embodiment, second OCR engine 34 may be a pattern-based OCR engine. A pattern-based OCR engine recognizes or identifies characters based on correlation of the character with known patterns. One OCR engine is different from another OCR engine such that the two OCR engines include different algorithms such that they are capable of producing different character or license plate number reads from the same image.

First OCR engine 32 and second OCR engine 34 transmit each of their read results. A read result includes both the license plate number and/or character reads and associated confidence levels, to comparator 36. Comparator 36 compares the first read to the second read. If the first read and the second read match, the camera system 30 produces the matching read as a final read.

If the first read and the second read do not match, a fusion module 38 produces a final read using the first read, the first confidence level, the second read, and the second confidence level. Fusion module 38 analyzes all candidate characters from each read result and computes the final read result that is most likely to be correct based on the confidence levels associated with each character.

In some embodiments, fusion module 38 selects at least one character from the first read and at least one character from the second read to produce the final read. In some embodiments, fusion module 38 selects all characters from only one of the first read or the second read. In some embodiments, fusion module 38 provides a third confidence level associated with the final read. In some embodiments, if the third confidence level is below a predefined threshold, the final read is designated as invalid.

Fusion module 38 and/or comparator 36 transmits the final read to communication module 39. Communication module 39 may transmit the final read and associated confidence level to an outside or back end system that uses the final read and may also use the associated confidence level for the desired application, such as tolling, parking enforcement, or other applications.

While the various components of camera system 30 are illustrated separately, they may be included or run by a single processor or any combination of processors. Further, as will be apparent to one of skill in the art upon reading the present disclosure, many variations of the present camera system are within the scope of the present invention. The camera system may include more than two OCR engines, it may include a camera module or multiple camera modules capable of capturing images through multiple channels and any combination thereof.

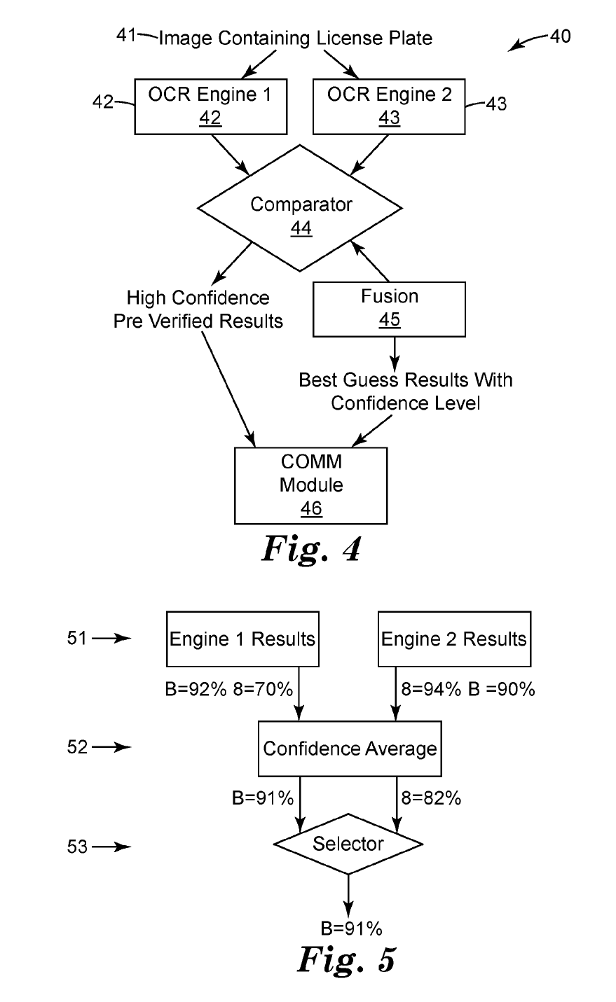

FIG. 4 is a process diagram for dual embedded OCR engines. Process 40 begins with each of the first OCR engine 42 and second OCR engine 43 receiving the image containing the license plate 41 from a camera module. Each of first OCR engine 42 and second OCR engine 43 produces a read result, both the license plate number and/or character reads and associated confidence levels, to comparator 44.

If the license plate number reads from each of the OCR engines match, the comparator transmits the matching read to the communication module 46 along with a confidence level based on the confidence level of each of the read results from each of the OCR engines. In many instances, the confidence level associated with this final read is expected to be relatively high because the two different OCR engines reached the same read.

If the license plate reads from each of the two OCR engines do not match, fusion module 45 produces a final read using the first read, the first confidence level, the second read, and the second confidence level. Fusion module 45 analyzes all candidate characters from each read result and computes the final read result that is most likely to be correct based on the confidence levels associated with each character.

In some embodiments, fusion module 45 selects at least one character from the first read and at least one character from the second read to produce the final read. In some embodiments, fusion module 45 provides a third confidence level associated with the final read. In some embodiments, if the third confidence level is below a predefined threshold, the final read is designated as invalid.

Fusion module 45 transmits the final read to communication module 46. Communication module 46 may transmit the final read and associated confidence level to an outside or back end system that uses the final read for the desired application, such as tolling, parking enforcement, or other applications.

FIG. 5 is an example process diagram for a fusion module. In step 51, the read results from the first OCR engine and the second OCR engine are transmitted to the fusion module. In some instances, only a single read result is transmitted from each OCR engine. In other instances, multiple read results from each OCR engine are transmitted to the fusion module.

In the example shown in FIG. 5, the read results for a given character in a license plate number are described. The first OCR engine identified that the character was a “B” and assigned a 92% confidence level with that result. The first OCR engine identified the character was alternately an “8” with an associated confidence level of 70%. The second OCR engine identified that the character was an “8” with an associated confidence level of 94%. The second OCR engine identified that the character was a “B” with an associated confidence level of 90%.

In step 52, the fusion module averages the confidence level for the top result from the first OCR engine (“B”; 92%) with the confidence level for that same result from the second OCR engine (90%) to identify an average confidence level for “B” of 91%. The fusion module also averages the confidence level for the top result from the second OCR engine (“8”; 94%) with the associate confidence level for the same result from the first OCR engine (70%) to identify an average confidence level for “8” of 82%.

In step 53, the fusion module compares the average confidence level associated with the top result from the first OCR engine (“B”; 91%) to the average confidence level associated with the top result from the second OCR engine (“8”; 82%) to select a final result for that given character of “B” because of the higher average confidence level.

The process shown in FIG. 5 looks at confidence values for both engines to determine the “best” result. This includes comparing not only first results but also less likely results. This approach is made possible by two way communication between each OCR engine and the fusion module that can query not just a final read result but the suite of possible results from each OCR engine. This two-way communication is enabled through the embedded configuration of the OCR engines, versus a configuration where OCR engines are externally connected to a camera or camera system.

It will be apparent to one of skill in the art that the method described for the fusion module is only an example of many computational methods that may be used to fuse read results from two or more different OCR engines. Multiple results from each OCR engine based on a single image may be fused. Multiple results from each OCR engine based on multiple engines may be fused. The range of computational methods within the scope of the present invention will be apparent to those of skill in the art upon reading the present disclosure.

The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

What is claimed is:

1. A camera system with dual embedded optical character recognition (OCR) engines comprising:
a camera module for capturing an image of a vehicle, the image including a license plate with a license plate number containing characters;
a feature-based OCR engine that produces a first read and first confidence level by extracting the characters from the license plate;
a pattern-based OCR engine, different from the first OCR engine, that produces a second read and second confidence level extracting the characters from the license plate;
a comparator for comparing the first read to the second read;
wherein if the first read and the second read match, the system produces the matching read as a final read;
wherein if the first read and the second read do not match, a fusion module produces a final read using the first read, the first confidence level, the second read, and the second confidence level.

2. The system of claim 1, wherein the fusion module selects at least one character from the first read and at least one character from the second read to produce the final read.

3. The system of claim 1, wherein the fusion module provides a third confidence level associated with the final read.

4. The system of claim 3, wherein if the third confidence level is below a predefined threshold, the final read is designated as invalid.

5. The system of claim 1, wherein the feature-based OCR engine and the pattern-based OCR engine evaluate the same image to produce the first read and the second read.

6. The system of claim 1, wherein the feature-based OCR engine and the pattern-based OCR engine evaluate different images to produce the first read and the second read.

7. The system of claim 1, wherein the feature-based OCR engine produces the first read from information received through a first channel, and wherein the pattern-based OCR engine produces the second read from information received through the second channel.

8. A method for producing a license plate final read, the method comprising:
providing a camera system with dual embedded optical character recognition (OCR) engines, wherein the camera system comprises a camera module, a feature-based OCR engine, a pattern-based OCR engine, a comparator and a fusion module;
capturing, with the camera module, an image of a vehicle, the image including a license plate with a license plate number containing characters;
producing a first read and first confidence level by extracting the characters from the license plate with the feature-based OCR engine;
producing a second read and second confidence level extracting the characters from the license plate with the pattern-based OCR engine;
comparing the first read to the second read;
if the first read and the second read match producing the matching read as a final read;
if the first read and the second read do not match, producing a final read with the fusion module, using the first read, the first confidence level, the second read, and the second confidence level.

9. The method of claim 8, wherein the fusion module selects at least one character from the first read and at least one character from the second read to produce the final read.

10. The method of claim 8, wherein the fusion module provides a third confidence level associated with the final read.

11. The method of claim 10, wherein if the third confidence level is below a predefined threshold, the final read is designated as invalid.

12. The method of claim 8, wherein the feature-based OCR engine and the pattern-based OCR engine evaluate the same image to produce the first read and the second read.

13. The method of claim 8, wherein the feature-based OCR engine and the pattern-based OCR engine evaluate different images to produce the first read and the second read.

14. The method of claim 8, wherein the feature-based OCR engine produces the first read from information received through a first channel, and wherein the pattern-based OCR engine produces the second read from information received through the second channel.

15. A camera system with dual embedded optical character recognition (OCR) engines comprising:
a camera module for capturing an image of a vehicle, the image including a license plate with a license plate number containing characters;
a first OCR engine that produces a first read and first confidence level by extracting the characters from the license plate;
a second OCR engine that produces a second read and second confidence level extracting the characters from the license plate;
a comparator for comparing the first read to the second read;
wherein if the first read and the second read match, the system produces the matching read as a final read;
wherein if the first read and the second read do not match, a fusion module produces a final read using the first read, the first confidence level, the second read, and the second confidence level.

16. The system of claim 15, wherein the fusion module selects at least one character from the first read and at least one character from the second read to produce the final read.

17. The system of claim 15, wherein the fusion module provides a third confidence level associated with the final read.

18. The system of claim 17, wherein if the third confidence level is below a predefined threshold, the final read is designated as invalid.

19. The system of claim 15, wherein the feature-based OCR engine and the pattern-based OCR engine evaluate the same image to produce the first read and the second read.

20. The system of claim 15, wherein the feature-based OCR engine and the pattern-based OCR engine evaluate different images to produce the first read and the second read.

21. The system of claim 15, wherein the feature-based OCR engine produces the first read from information received through a first channel, and wherein the pattern-based OCR engine produces the second read from information received through the second channel.
